(19) United States
(12) Patent Application Publication
(10) Pub. No.: US 2019/0305434 A1
(43) Pub. Date: Oct. 3, 2019

(54) Connection Arrangement

(71) Applicant: TE Connectivity Nederland BV, S'Hertogenbosch (NL)

(72) Inventors: Martinus E.J.J. Panis, Den Dungen (NL); Mohadig Widha Rousstia, Eindhoven (NL)

(73) Assignee: TE Connectivity Nederland BV, S'Hertogenbosch (NL)

(21) Appl. No.: 16/447,520

(22) Filed: Jun. 20, 2019

Related U.S. Application Data
(63) Continuation of application No. PCT/EP2017/083951, filed on Dec. 20, 2017.

(30) Foreign Application Priority Data
Dec. 23, 2016 (EP) 16206822.5

(51) Int. Cl. H01Q 13/08; H01P 1/17; H01P 3/16; H01Q 1/38

(52) U.S. Cl. CPC H01Q 13/08; H01Q 1/38; H01P 3/165; H01P 1/173

(57) ABSTRACT

A connection arrangement comprises an antenna adapted to transmit and/or receive electromagnetic waves and a waveguide member adapted to transport the electromagnetic waves. An end section of the waveguide member is arranged at the antenna in a transmission state such that an electromagnetic radiation can be transmitted between the antenna and the waveguide member. The waveguide member has a recess extending from a free end of the waveguide member into the waveguide member. The antenna is at least partially inserted in the recess in the transmission state.

### CROSS-REFERENCE TO RELATED APPLICATIONS

This application is a continuation of PCT International Application No. PCT/EP2017/083951, filed on Dec. 20, 2017, which claims priority under 35 U.S.C. § 119 to European Patent Application No. 16206822.5, filed on Dec. 23, 2016.

### FIELD OF THE INVENTION

The present invention related to a connection arrangement and, more particularly, to a connection arrangement for the transmission and reception of electromagnetic waves, in particular in the millimeter-wave frequency range.

### BACKGROUND

A connection arrangement comprises an antenna for transmitting and/or receiving electromagnetic waves and at least one waveguide member for transporting the waves. Generally, the waveguide member is brought close to or into direct contact with the antenna for coupling of electromagnetic waves from the antenna into the waveguide member and vice versa. A proper alignment of these components relative to each other is important in order to reduce loss and achieve a good coupling efficiency. However, the alignment may be time and cost consuming. Further, the arrangement of the antenna and the waveguide member often requires a large volume.

### SUMMARY

A connection arrangement comprises an antenna adapted to transmit and/or receive electromagnetic waves and a waveguide member adapted to transport the electromagnetic waves. An end section of the waveguide member is arranged at the antenna in a transmission state such that an electromagnetic radiation can be transmitted between the antenna and the waveguide member. The waveguide member has a recess extending from a free end of the waveguide member into the waveguide member. The antenna is at least partially inserted in the recess in the transmission state.

### BRIEF DESCRIPTION OF THE DRAWINGS

The invention will now be described by way of example with reference to the accompanying Figures, of which:

FIG. 1 is a perspective view of a connection arrangement according to an embodiment in a transmission state;

FIG. 2 is a perspective view of a waveguide member of the connection arrangement of FIG. 1;

FIG. 3 is a perspective view of a connection arrangement according to another embodiment in a transmission state;

FIG. 4 is a sectional perspective view of an antenna of the connection arrangement of FIG. 3; and

FIG. 5 is a perspective view of an antenna for a connection arrangement according to another embodiment.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. The various features shown in the embodiments may be used independently of each other in specific applications.

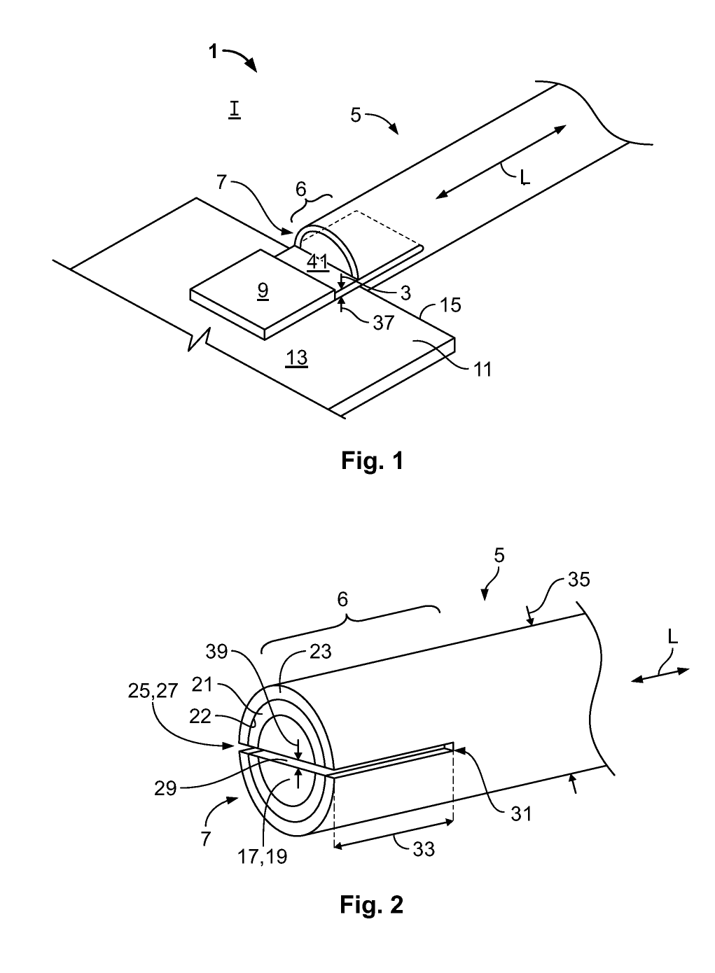

A connection arrangement 1 according to an embodiment is shown in FIG. 1. The connection arrangement 1 comprises an antenna 3 and a waveguide member 5. The arrangement 1 is shown in a transmission state T in FIG. 1. In the transmission state T, the antenna arrangement 3 and the waveguide member 5 are arranged such that electromagnetic waves can be coupled from the antenna 3 into the waveguide member 5 and vice versa.

The waveguide member 5, as shown in FIGS. 1 and 2, has an end section 6 with a free end 7. The end section 6 is connected to the antenna 3. The waveguide member 5 has a second free end formed similar to the free end 7 and which may be connected to a similar antenna 3. In this embodiment, the connection arrangement 1 may comprise one waveguide member 5 and two antennas 3.

As shown in FIG. 1, the antenna 3 is connected to at least one communication circuit 9 which may be a transmitter, a receiver, or a combined transceiver. In an embodiment, the antenna 3 is connected to a printed circuit board (PCB) 11 or monolithically integrated with the PCB 11. The antenna 3 is formed as PCB, in particular a low-loss PCB at millimeter-wave frequency range. The antenna 3 may be rigid or flexible.

In the shown embodiment, the antenna 3 has an overall rectangular flat shape indicated by the dashed line in FIG. 1. The rectangular shape extends parallel to or identical with a plane 13 of the PCB 11. The antenna 3 protrudes away from the PCB 11 along a longitudinal direction L, such that it extends beyond a front edge 15 of the PCB 11, such that a connection with the waveguide member 5 is possible.

The waveguide member 5 has an overall longitudinal shape and extends along the longitudinal direction L in the transmission state T, as shown in FIG. 1. In an embodiment shown in FIG. 2, at least a core 17 of the waveguide member 5 is made from polymer fiber 19. In other embodiments, the core 17 may be made from other materials, in particular polymer materials, for example, foamed polymer material. In another embodiment, the core 17 may be made from materials such as glass. At least the core 17 is solid in an embodiment, except for the free ends where recesses may be present. In an embodiment, the waveguide member 5 may be short and may form a cap for the antenna 3 to be connected to other waveguiding components. In an embodiment, the waveguide member 5 has a circular shape in a cross-section perpendicular to the longitudinal direction L. In other embodiments, the waveguide member 5 may have a cross-section with a different shape, such as rectangular or polygonal.

As shown in FIG. 2, the core 17 may be surrounded along a circumferential direction by additional layers which can be chosen according to the required electric and/or mechanic properties. In particular, the layers may surround the core 17 in a sleeve-like manner. In an embodiment, the core 17 is surrounded by a dielectric layer 21, a shield 22, and an outer layer 23. In an embodiment, the dielectric layer 21 is made from a material with a dielectric constant that is lower than that of the core 17. The shield 22 is formed as a metallic shield 22 for signal confinement and the outer layer 23 may be made from plastic material for protection of the waveguide member 5.

In the end section 6, as shown in FIG. 2, the waveguide member 5 has a recess 25 which is formed as a slit 27. The recess 25 extends through a center 29 of the cross section of the waveguide member 5. The cross section runs perpendicular to the longitudinal direction L. The recess 25 extends from the free end 7 into the waveguide member 5 along the longitudinal direction L. The end of the recess 25 is formed by a bottom 31. In various embodiments, the recess 25 is formed by molding, cutting or other suitable techniques.

The waveguide member 5 is laterally opened by the recess 25 in the end section 6, as shown in FIG. 2; the recess 25 also extends through the layers 21, 22 and 23. The openings in the layers 21, 22 and 23 are arranged diametrically to each other across the center 29. A penetration depth 33 of the recess 25 into the waveguide member 5 is, in the first embodiment shown in FIG. 2, larger than an outer diameter 35 of the waveguide member 5. In an embodiment, the penetration depth 33, which is measured from the free end 7 to the bottom 31 along the longitudinal direction L, is larger than 0% and up to 200% of the diameter 35.

The recess 25 is formed complementary to the antenna 3 such that the antenna 3 can be received in the recess 25 in the transmission state T, at least with its common layer end face 40, as shown in FIG. 1. In an embodiment, the antenna 3 abuts the bottom 31 in the transmission state T. Inserting the antenna 3 at least partially into the recess 25 of the waveguide member 5 can guarantee that both components are afterwards arranged in a predefined position relative to each other. Further, the presence of at least a part of the antenna 3 in the recess 25 of the waveguide 5 member may guarantee a good coupling of the components with each other and thereby ensure a high transmission quality and reduce signal loss. Finally, the arrangement helps to save space.

In an embodiment, a thickness 37 of the antenna is identical to a width 39 of the slit 27. The thickness 37 and the width 39 are measured perpendicular to the longitudinal direction L and perpendicular to the plane 41 of the antenna 3 in the transmission state T. The plane 41 of the antenna 3 is parallel to or identical with the plane 13 of the PCB 11. In the case that the thickness 37 and the width 39 are identical, the antenna 3 may be tightly fitted in the recess 25 such that no or only a very small amount of a surrounding medium such as air is present between the antenna 3 and the material of the core 17 in the transmission state T. It should be noted that “being identical” includes typical deviations due to the production, which may sum up to around 5% of the thickness 37 and or the width 39. The thickness 37 of the antenna 3 is less than 25% of the diameter 35 of the waveguide member 5 in this embodiment.

In the transmission state T, the plane 41 of the antenna 3 extends parallel to the longitudinal direction L. The antenna 3 and the waveguide member 5 are arranged along the same axis, which is defined by the longitudinal direction L. This improves the signal transmission between the antenna 3 and the waveguide member 5 and may reduce signal loss. Inserting the antenna 3 into the recess 25 of the waveguide member 5 facilitates coupling of these components. Thereby, a compact design is achieved and the coupling performance between the antenna 3 and the waveguide member 5 may be improved.

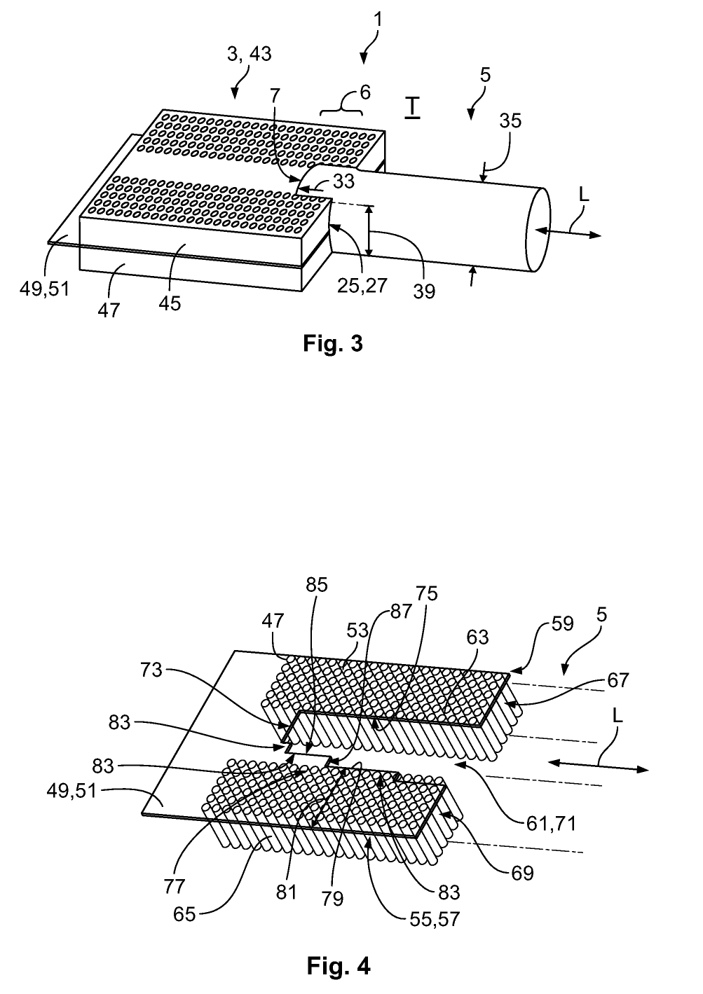

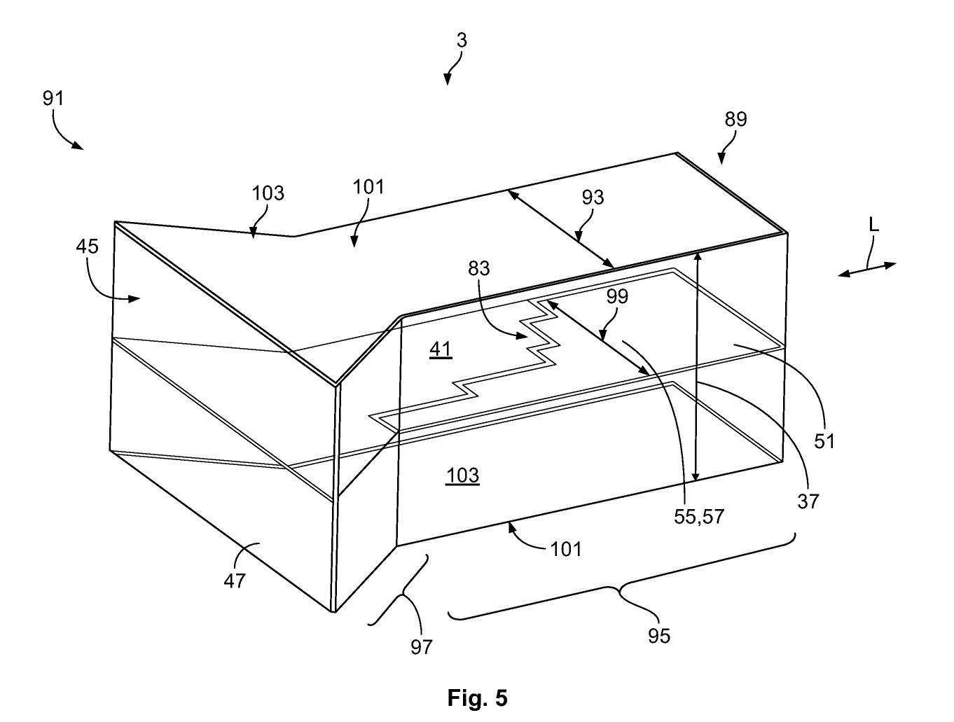

A connection arrangement 1 according to another embodiment is shown in FIGS. 3 and 4. Only the differences with respect to the aforementioned embodiments are described in detail herein.

As shown in FIG. 3, the recess 25, which is formed as a slit 27 has a penetration depth 33 which is smaller than 50% of the diameter 35 of the waveguide member 5. Alternatively, the depth 33 may be larger than 0% and up to 200% of the diameter 35. The width 39 of the slit 27 is, in this embodiment, larger than the penetration depth 33. In an embodiment of a connection arrangement 1 in which the antenna 3 abuts the waveguide member 5 without being inserted, the depth 33 is consequently 0% of the diameter 35.

The antenna 3, as shown in FIGS. 3 and 4, is formed as a printed circuit board 43 with two outer layers 45 and 47 and a central layer 49, or septum. The central layer 49 is formed as microstrip 51 in an embodiment. The central layer 49, in various embodiments, is made from copper or metal which contains mostly copper. The outer layers 45 and 47 are provided with a plurality of through holes, or vias, 53. The through holes 53 can be used for adjusting the electromagnetic properties of the antenna 3. The through holes 53 basically extend perpendicular to the longitudinal direction L and to a plane defined by the central layer 49. In an embodiment, the through holes 53 are provided with metalized inner walls.

The central layer 49 comprises a structure which is capable of polarizing electromagnetic radiation which is emitted from the antenna 3. The antenna 3 is therefore provided with a polarizing element 55. In an embodiment, the polarizing element 55 is a circular polarizer 57 as shown in FIG. 4.

Circular polarization allows the waveguide member 5 and the antenna 3 to be assembled to form a connection arrangement 1 independently from a rotational position with respect to the longitudinal direction L. If, for example, the recess 25 is formed as a slit 27 which extends through a center of the cross section of the waveguide member 5, then the waveguide member 5 and the antenna 3 can be rotated by 180 degrees around the longitudinal direction L and will achieve the same coupling results in the transmission state T, leading to easier assembly of the arrangement 1.

The structure capable of polarizing electromagnetic radiation has an overall U-shape 59, as shown in FIG. 4, which is formed as a recess 61 which extends from the waveguide member 5 into the central layer 49 along the longitudinal layer L. The U-shape comprises a first leg 63 and a second leg 65 which extend along the longitudinal direction L, wherein free ends 67 and 69 of the legs 63 and 65 point in the direction of the waveguide member 5.

The free space 71 between the legs 63 and 65, which is formed by the recess 61, tapers from the free ends 67 and 69 towards the bottom 73 of the U-shape 59 along the longitudinal direction L. Thereby, the first leg 63 comprises an inner side 75 which runs basically parallel to the longitudinal direction L. The opposite second leg 65 comprises a stepped structure 77 on its inner side 79 such that a width 81 of the second leg 65 stepwise increases from the free end 69 towards the bottom 73. The width 81 of the leg 65 is measured perpendicular to the longitudinal direction L and in the plane of the central layer 49.

Each of the steps 83, as shown in FIG. 4, has a first edge 85 and a second edge 87, which are arranged perpendicular to each other. The first edge 85 basically extends parallel with the longitudinal direction L and, consequently, the second edge 87 basically extends perpendicular to the longitudinal direction L. The lengths of the first edges 85 increase for each step 83 parallel to the longitudinal direction L from the bottom 73 towards the free end 69.

In the transmission state T, the polarizer 55 is at least partially inserted in the recess 25.

An antenna 3 for a connection arrangement 1 according to another embodiment is shown in FIG. 5. The antenna 3 may, for example, be used in the arrangement 1 as described with respect to FIGS. 3 and 4. Only the differences to the aforementioned embodiments are described in detail herein.

The antenna 3, as shown in FIG. 5, has an overall longitudinal shape extending along the longitudinal direction L. In the longitudinal direction L, the antenna 3 has a connection end 89 and a waveguide end 91. The connection end 89 can be used for connecting the antenna 3 to a communication circuit 9. The waveguide end 91 can be used for being coupled to a waveguide member 5; in an embodiment, the waveguide end 91 can be used for being coupled to a waveguide member 5 as described with respect to FIGS. 3 and 4.

The antenna 3 has a constant thickness 37 along the longitudinal direction L. However, a width 93 of the antenna 3 varies along the longitudinal direction L. The width 93 of the antenna 3 is measured perpendicular to the longitudinal direction L and perpendicular to the direction of the thickness 37. As shown in FIG. 5, the width 93 of the antenna 3 varies such that a first section 95 is formed, which has a constantly shaped cross section along the longitudinal direction L. The width 93 and the thickness 37 of the antenna 3 remain constant along the longitudinal direction L in the first section 95. The first section 95 starts at the connection end 89 and extends in the direction of the waveguide end 91.

In a second section 97 of the antenna 3, as shown in FIG. 5, the width 93 of the antenna 3 varies along the longitudinal direction L. The width 93 varies such that it is larger than in the first section 95 at the waveguide end 91 and decreases towards the first section 95. In other words, the antenna 3 tapers towards the first section 95 in the second section 97. Seen along the direction of the thickness 37 of the antenna 3, the antenna 3 thereby has an overall funnel-like shape.

The antenna 3 in the embodiment of FIG. 5, as in the embodiment of FIGS. 3 and 4, comprises two outer layers 45 and 47 and a central layer 49, which is arranged between the outer layers 45 and 47. In an embodiment, the outer layers 45 and 47 are made from a dielectric material, for example the material of a printed circuit board.

The central layer 49 comprises a polarizer 55, in particular a circular polarizer 57 which is formed as a microstrip 51 in the embodiment of FIG. 5. The circular polarizer 57 comprises steps 83 which form a step structure 77. A width 99 of the circular polarizer 57 decreases with every step 83 in the longitudinal direction L towards the second section 97. In other words, the polarizer 57 is basically shaped as the second leg 65 as described with respect to FIG. 4.

The outer layers 45 and 47 are not provided with vias or through holes 53 in the embodiment of FIG. 5. Instead, the antenna 3 comprises metalized sidewalls 101 and 103. The sidewalls 101 are arranged on top and bottom of the antenna 3 and are consequently even and flat along the longitudinal direction L. The sidewalls 101 are arranged parallel with each other and extend parallel with the direction of the width 93 of the antenna 3 and the longitudinal direction L. The sidewalls 103 are arranged opposite to each other along the direction of the width 93 of the antenna 3. Consequently, the sidewalls 103 extend parallel with each other in the first section 95 and diverge in the second section 97.

What is claimed is:

1. A connection arrangement, comprising:
an antenna adapted to transmit and/or receive electromagnetic waves; and
a waveguide member adapted to transport the electromagnetic waves, an end section of the waveguide member is arranged at the antenna in a transmission state such that an electromagnetic radiation can be transmitted between the antenna and the waveguide member, the waveguide member has a recess extending from a free end of the waveguide member into the waveguide member, the antenna is at least partially inserted in the recess in the transmission state.

2. The connection arrangement of claim 1, wherein the recess and the antenna are formed at least partially complementary to each other.

3. The connection arrangement of claim 1, wherein the waveguide member has an overall longitudinal shape and the recess extends along a longitudinal direction of the waveguide member.

4. The connection arrangement of claim 1, wherein the recess is formed as a slit extending into the waveguide member.

5. The connection arrangement of claim 4, wherein the slit extends through a center of a cross-section of the waveguide member.

6. The connection arrangement of claim 5, wherein the waveguide member is laterally opened by the slit.

7. The connection arrangement of claim 1, wherein the recess has a penetration depth measured from a free end of the waveguide member to a bottom of the recess, the penetration depth is greater than 0% and less than 200% of a diameter of the waveguide member.

8. The connection arrangement of claim 1, wherein the waveguide member has a core that is solid.

9. The connection arrangement of claim 1, wherein the waveguide member has a core formed from a polymer material.

10. The connection arrangement of claim 1, wherein the antenna is at least partially formed as a printed circuit board.

11. The connection arrangement of claim 1, wherein the antenna has a polarizer.

12. The connection arrangement of claim 1, wherein the polarizer is at least partially arranged in the recess in the transmission state.

13. A method for assembling a connection arrangement, comprising:
providing an antenna adapted to transmit and/or receive electromagnetic waves and a waveguide member adapted to transport the electromagnetic waves; and
inserting at least a portion of the antenna into a recess of the waveguide member for transmitting the electromagnetic waves between the antenna and the waveguide member.

14. A waveguide member for transporting electromagnetic waves, comprising:
a recess disposed at a free end of the waveguide member and extending into the waveguide member, the recess at least partially receiving an antenna.

15. An antenna for transmitting and/or receiving electromagnetic waves, comprising:
a portion adapted to be at least partially inserted into a waveguide member.
